(19) United States
(12) Patent Application Publication
(10) Pub. No.: US 2011/0191979 A1
(43) Pub. Date: Aug. 11, 2011

(54) Methods of Using Cutting Devices for Printing, Devices for Performing the Same, and Systems including such Devices

(76) Inventors: Dane A. Boren, (US); Dru C. Boren, (US)

(21) Appl. No.: 13/020,003

(22) Filed: Feb. 2, 2011

Related U.S. Application Data
(60) Provisional application No. 61/300,740, filed on Feb. 2, 2010.

(51) Int. Cl. B43K 3/00

(52) U.S. Cl. 15/435

(57) ABSTRACT

Methods of using cutting devices for printing, devices for performing the same, and systems including such devices are disclosed. More specifically, interchangeable writing implements and writing implement holders are disclosed which are designed to replace blade holders of various cutting devices.

### RELATED APPLICATIONS

This application claims the benefit of U.S. Provisional Application Ser. No. 61/300,740 filed Feb. 2, 2010, the content of which is incorporated herein by reference in its entirety.

### FIELD OF THE INVENTION

The invention generally relates to cutting devices, and particularly to methods of using cutting devices for printing, devices for performing the same, and systems including such devices.

### BACKGROUND OF THE INVENTION

Personal die cutting machines provide scrapbooking and craft enthusiasts with ability to cut perfect shapes and letters out of media such as paper, cardstock, and other lightweight materials. The very first personal die cutters were manual machines. However, personal die cutters are becoming more sophisticated. Electronic versions borrowed from the sign-making industry have been adapted for use in the personal scrapbooking and craft industry. These electronic cutting devices use software and computers to control the cutting blade. Cutting devices are expensive, and many consumers are forced to spend even more money on the software and/or computers used to control the device. However, even after significant investments scrapbooking and craft enthusiasts only use their cutting device for one function: cutting. It would be beneficial to scrapbooking and craft enthusiasts to use their cutting device to perform additional functions. Expanding the functions of a cutting device would give more options to the creative endeavors of scrapbooking and craft enthusiasts.

Thus, there is a need to expand the functional uses of cutting devices.

### BRIEF SUMMARY OF THE INVENTION

The present invention relates to methods of using cutting devices for printing, devices for performing the same, and systems including such devices.

In one embodiment, the present invention includes a writing implement holder comprising: a housing comprising an open first end, a closed second end, and a surface connecting said open first end with said closed second end, wherein an inner cavity is formed by said surface, wherein said inner cavity is configured for mating with a writing implement and wherein the exterior of said surface is configured to replace a blade holder of a cutting device and configured to removably mate with said cutting device and allow use of said writing implement in place of a blade with the cutting device.

In some variations of such embodiments, the housing comprises a tube comprising an open first end and a closed second end, wherein the inner surface of said tube forms said inner cavity and is configured for mating with a writing implement and wherein the outer surface of said tube forms the exterior of said surface and is configured to replace a blade holder of a cutting device and configured to removably mate with said cutting device to allow use of said writing implement in place of a blade with said cutting device.

In another embodiment, the present invention includes a writing implement system comprising: a cutting device; and a writing implement holder which has a housing configured for mating with a writing implement. The housing is also configured to replace a blade holder of a cutting device. The writing implement holder can removably mate with the cutting device and allow use of the writing implement in place of a blade with the cutting device.

Methods are also disclosed that use the writing implements and writing implement holders of the present invention. In one embodiment, users may use a cutting device to draw with a writing implement by: replacing a blade holder of a cutting device with a writing implement holder of the present invention. The writing implement holder comprises a housing comprising an open first end and a closed second end. The inner surface of said housing is configured for mating with a writing implement, and the outer surface of the housing is configured to replace a blade holder of a cutting device. The writing implement holder is configured to removably mate with the cutting device and allow use of the writing implement in place of a blade with the cutting device.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1a is a front view of one embodiment of a writing implement holder;

FIG. 1b is a front view of a writing implement secured by one embodiment of a writing implement holder;

FIGS. 2a-2c are side views of some embodiments of writing implement holders;

FIG. 3a is a front perspective view of one embodiment of a writing implement holder with a magnet and steel plug removed;

FIG. 3b is a front perspective view with a closed second end cross section of one embodiment of a writing implement holder showing magnet and plug located at the closed second end of the housing;

FIG. 3c is a front perspective view with a closed second end cross section of one embodiment of a writing implement holder showing a magnet located at the closed second end of the housing;

FIG. 4 shows a writing implement mated to one embodiment of a writing implement holder with the writing implement holder removably mated to a cutting device;

FIG. 5 shows a front perspective view of a cutting device;

### DETAILED DESCRIPTION OF THE INVENTION

The embodiments of the present invention allow many different types of writing implements to be utilized by a cutting device. Illustrative embodiments are shown in detail in the drawings. Further, the embodiments described herein are not intended to be exhaustive or otherwise limit or restrict the claims to the precise form and configuration shown in the drawings and disclosed in the following detailed description.

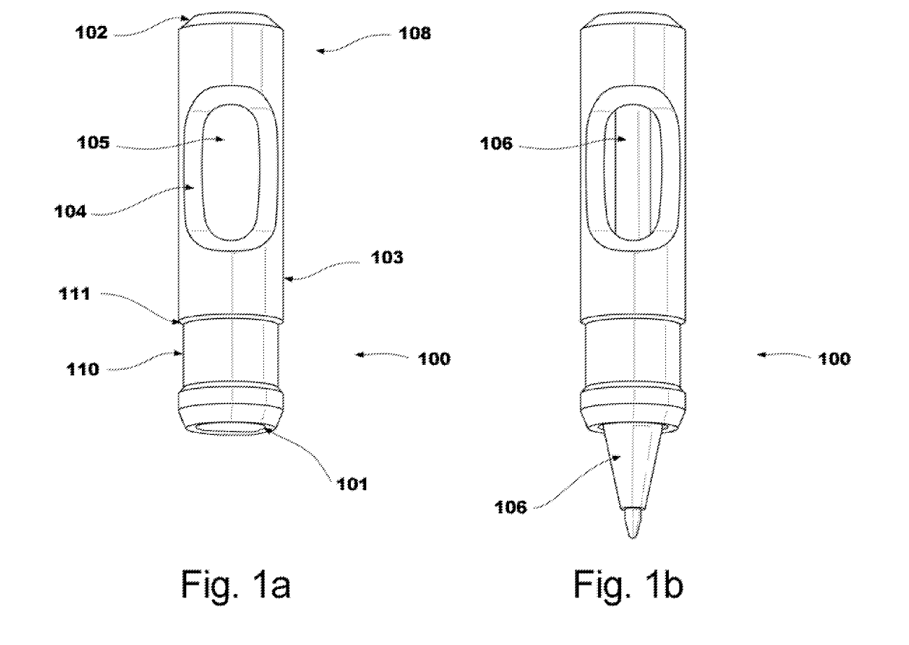

One embodiment of the present invention is illustrated in FIG. 1a. A writing implement holder 100 has a tube shaped housing 108 with an open first end 101, a closed second end 102, and a surface 103 connecting the open first end with the closed second end. The inner surface of the tube forms an inner cavity 105 and is configured for mating with a writing implement. The outer surface of the tube forms the exterior of the surface 103 and is configured to replace a blade holder of a cutting device and is configured to removably mate with the cutting device. This configuration allows the writing implement and writing implement holder to be used in place of the blade and blade holder of a cutting device.

In addition, the writing implement 100 also comprises a hole 104 in the surface of the tube shaped housing 108. The hole 104 allows slidable access to the writing implement 106 and provides visibility into the inner cavity 105 of the tube shaped housing 108. The hole 104 is configured to allow slidable access to the writing implement when the writing implement 106 is mated with the inner cavity 105 of the tube shaped housing 108. The hole 104 is located in the side of the tube shaped housing approximately halfway along the length of the exterior of the surface 103, and is large enough to allow a finger to reach the inner cavity 105.

In another embodiment illustrated by FIG. 1b, the writing implement holder 100, is mated with a writing implement 106. To insert the writing implement 106 into the writing implement holder 100, the writing implement 106 is slid through the open first end 101 of the tube shaped housing 108. The writing implement 106 extends beyond the open first end 101 to expose the writing tip of writing implement 106. The writing implement 106 is visible from the hole 104 in the surface of the tube shaped housing 108. The writing implement 106 may be removed from the writing implement holder 100 by grabbing the writing implement tip, or by means of the hole 104 by sliding the writing implement 106 downward toward the open first end 101. In some embodiments, including the embodiment illustrated by FIG. 1b, the writing implement 106 is a gel pen. The writing implement holder 100 allows the writing implement 106 to mark, write, draw, paint, trace, emboss, or engrave on media within the cutting device.

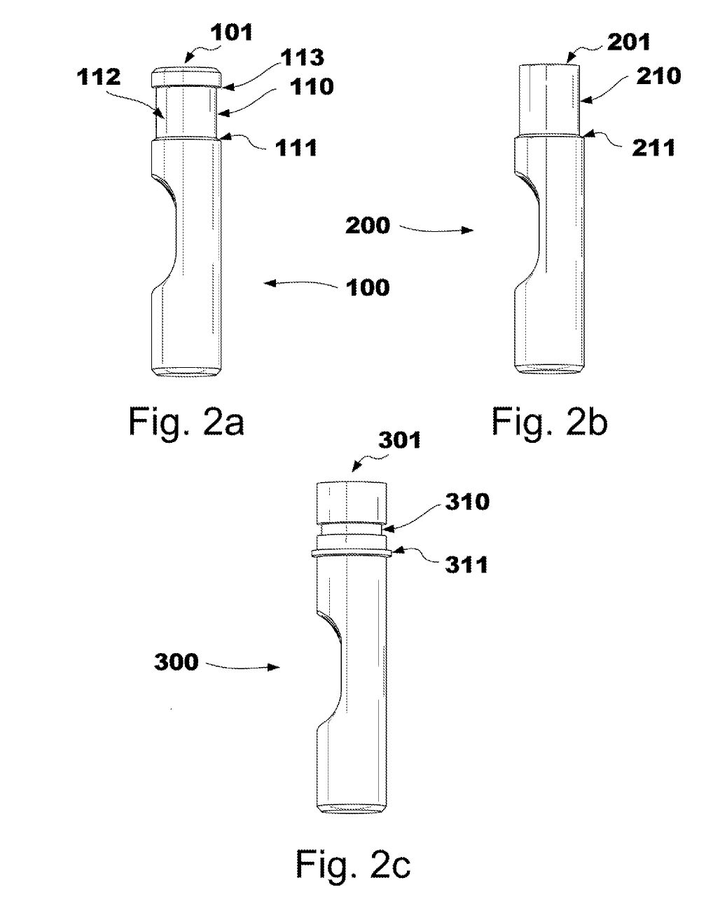

Writing implements 106 and writing implement holders 100 may be designed to fit with any type of cutting device. Referring now to FIG. 2a, a writing implement holder 100 is designed to mate with the cutting devices sold under the trademarks Cricut® and Inspiration®. The writing implement holder 100, comprises an outer surface with a reduced diameter section 110 proximate the first open end 101 that has a reduced diameter compared to the diameter of the remainder the exterior of the surface 103. The reduced diameter section 110 creates a bottom edge 112 and a side edge 113, and a side edge 111 which acts as a stop collar when downward pressure is exerted by the cutting device. The bottom edge 112 and side edge 111 are configured to removably mate with said cutting device.

In another embodiment illustrated by FIG. 2b, the writing implement holder 200 is designed to fit within the cutting device sold under the trademark Silhouette SD®. In this embodiment, the exterior of surface 103 of the tubed shaped housing 108 has a reduced diameter section 210 proximate to the first open end 201 that has a reduced diameter compared to the diameter of the remainder the exterior of surface 103. This reduced diameter section 210 also creates a top edge 211 that acts as a stop collar when downward pressure is exerted by the cutting device. The reduced section 210 and top edge 211 are configured to removably mate with a cutting device.

In yet another embodiment illustrated by FIG. 2c, the writing implement holder 300 is designed to fit within the cutting device sold under the trademark Eclips®. In this embodiment, the exterior of surface 103 of the tube shaped housing 108 proximate to the open first end 301 includes a recessed band 310 that is configured to removably mate with the cutting device. Additionally, the exterior surface 103 of the tube shaped housing 108 proximate to the first open end 301 also includes a protruding ring 311 extending from the exterior surface 103 and proximate to the recessed band 310. This protruding ring 311 and recessed band 310 are configured to removably mate with a cutting device.

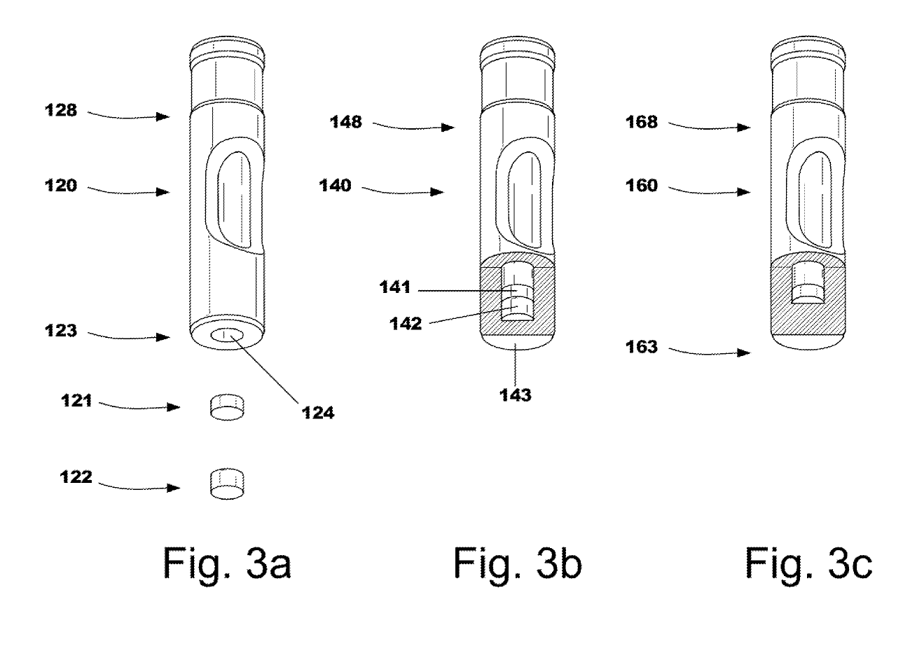

In some embodiments, the writing implement holder 100 has a closed end, which is configured for magnetically securing the writing implement 106. In the embodiments illustrated by FIGS. 3a and 3b, a ferromagnetic backing plate 122 is used in conjunction with the magnet 121. This backing plate 122 is used to focus the majority of magnetic energy toward the open end of the housing.

In the embodiment illustrated by FIG. 3a, the writing implement holder 120 has a closed second end 123 that is completed by a magnet 121 magnetically attached to a magnetically-attractive plug 122. The magnetically-attractive plug 122 may be composed of steel, and inserted and secured into a hole 124 located at the second closed end 123 of the tube shaped housing 128. As mentioned above, magnetically-attractive plug 122 also acts as a ferromagnetic backing plate to focus magnetic energy toward the open end of the housing. When inserted, the magnet 121 and magnetically attractive plug 122 closes the closed second end 123 of the tube shaped housing 128. The magnet 121 is placed nearest to the writing implement 106 and mates with a magnetically-attractive writing implement.

In the embodiment of FIG. 3b, the writing implement holder 140 has a magnet 141 and a metal piece 142 secured near the closed second end 143 of the tube shaped housing 148. The magnet 141 and a magnetically-attractive piece 142 are place at the closed second end 143 of the writing implement 140. The magnet 141 is placed nearest to the writing implement 106 and mates with a magnetically-attractive writing implement.

It should be understood that the cariations discussed regarding writing implement holders 100, 120, 140, and 160, may be applied to writing implement holders 200 and 300.

In yet another embodiment FIG. 3c, the writing implement holder 160 has a magnet 121 located or secured near the closed end of the housing. In some embodiments, the housing of the writing implement holder is composed of a magnetically-attractive material.

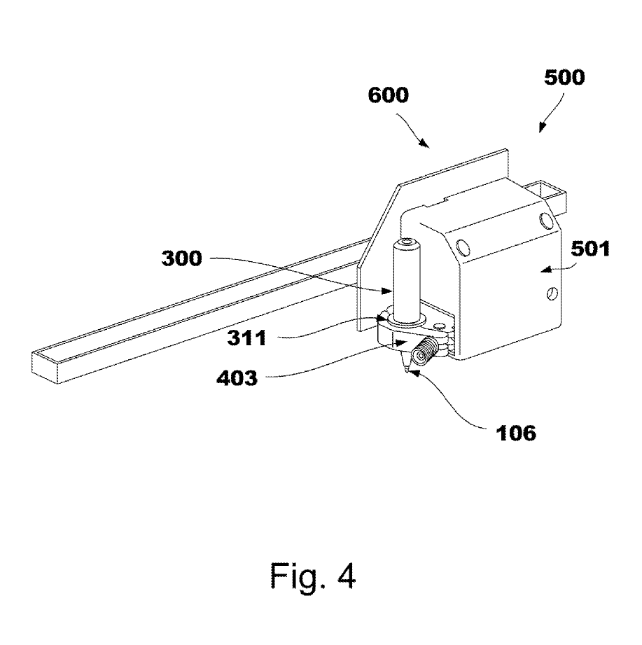

In some embodiments, the present invention also provides for a writing implement system 600 comprising: a cutting device 500 and a writing implement holder 300 of the present invention 400. In FIG. 4, the writing implement holder 300 is shown attached to the head unit 501 of a cutting device 500 (not shown). The writing implement 106, which is mated with the writing implement holder 300, is secured by a mechanism 403 on the head unit 501. The writing implement holder 300 is configured to mate with mechanism 403 in the cutting device. Thus, the reduced section 310 (not shown) and protruding ring 311 of the exterior of surface 308 of the writing implement holder have been configured to mate with head unit 501. In some embodiments the writing implement 106, is a gel pen.

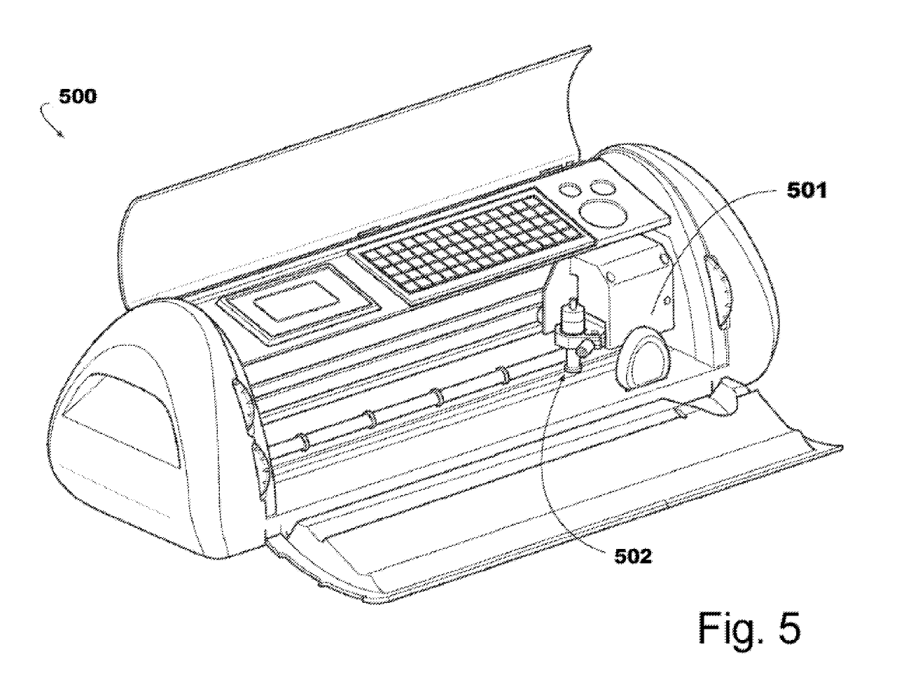

In FIG. 5, the blade holder 502 is shown attached to the head unit 501 and the head unit 501 is attached to the cutting device 500. In some embodiments, the blade holder of a cutting device is removed and replaced with any embodiment of a writing implement holder of the present invention as seen in

Methods are disclosed that use the embodiments of writing implement holders of the present invention. In one embodiment, users may use a cutting device to draw with a writing implement by: replacing a blade holder of a cutting device with a writing implement holder wherein said writing implement holder comprises: a housing comprising an open first end and a closed second end, wherein the inner surface of said housing is configured for mating with a writing implement, and wherein the outer surface of said housing is configured to replace a blade holder of a cutting device and configured to removably mate with said cutting device and allow use of said writing implement in place of a blade with said cutting device. Further steps may include: mating a writing implement with said inner surface of said housing of said writing implement holder. The writing implement may comprise a gel pen. In other embodiments the writing implement may include an embosser or engraver.

After replacing the blade holder with the writing implement and/or the writing implement holder of the present invention a user may take further steps comprising programming a first pattern into said cutting device, inserting desired media into said cutting device, and activating said cutting device so as to draw said first pattern on said desired media with said writing implement. In some embodiments, the method includes drawing many different patterns with the same writing implement or substituting or interchanging a plurality of writing implements. Thus, a user may draw a plurality of patterns with a plurality of writing implements. In other embodiments a user may program a second pattern into said cutting device, and activate said cutting device so as to draw said second pattern on said desired media with said writing implement.

After using the writing implement and writing implement holders in the cutting machine on the desired media a user may take a further step comprising replacing said writing implement holder with said blade holder, inserting a blade, and activating said cutting device so as to cut said a pattern into the desired media with said blade wherein the media had markings, writings, drawings, paintings, traces, embossing, or engraving on media and wherein said markings, writings, drawings, paintings, traces, embossing, or engraving where made by the writing implement secured by the writing implement holder of the present invention.

In some embodiments a blade holder is removed from a cutting device and replaced with a writing implement and writing implement holder of the present invention. A “writing implement” is a tool that can mark media without cutting it. Writing implements of the present invention include but are not limited to pens, gel pens, markers, pencils, embossers, and engravers. Writing implements and writing implement holders of the present invention allow users to mark, write, draw, paint, trace, emboss, or engrave on media with their cutting device. In addition, the writing implements and implement holders of the present invention are interchangeable, and users may use a plurality of writing implements on a single medium within a cutting device.

Electronic cutting devices use software and computers to control the cutting blade. Electronic cutting devices, such as that illustrated in FIG. 5, may look similar to an inkjet printer and can be roughly the same size. Generally, there are two types of electronic cutting devices: (1) cartridge based cutters; and (2) computer controlled cutters.

Cartridge-based cutters require a cartridge to store a library of pre-set cutting instructions for the desired image, font, design, shape, pattern, or sentiment. Operating the cutter usually involves inserting the cartridge, selecting a shape or series of shapes to be cut, setting the speed and depth of the cut (i.e., the pressure that the blade will use) and then pressing a button to execute the cut. Examples of cartridge-based cutting devices are sold under the trademarks of Xyron Personal Cutting System or XPCS® and Cricut® manufactured by Xyron, Inc. and Provo Craft and Novelty, Inc., respectively. Another example of a cartridge based cutting device is sold under the trademark of Eclips® and is manufactured by Sizzix, Inc.

Computer-controlled cutters are connected to a computer and design software allows the operator to draw and trace shapes, which can then sent to the machine for cutting. Thus, a computer-controlled cutter is capable of cutting an infinite variety of shapes and letters, without the need of cartridges. An example of computer controlled cutter is manufactured by Pazzles, Inc., and is sold under the trademark Inspiration®. Another example of a computer-based cutter is manufactured by Silhouette America, Inc. and sold under the trademark Silhouette SD®. Some cutting devices are able to accept cartridges and receive software or cutting instructions from a computer.

In some embodiments, the housing is not tube shaped. This embodiment comprises: a housing comprising an open first end, a closed second end, and a surface connecting said open first end with said closed second end, wherein an inner cavity is formed by said surface, wherein said inner cavity is configured for mating with a writing implement and wherein the exterior of said surface is configured to replace a blade holder of a cutting device and configured to removably mate with said cutting device and allow use of said writing implement in place of a blade with said cutting device.

In some embodiments, the writing implement holder is joined or mated with a writing implement. In some embodiments, the writing implement in the writing implement holder is a gel pen. In other embodiments, the writing implement is an embosser or engraver. Embossing is the process of creating a three-dimensional image or design in paper, foil, or other lightweight media. It can be accomplished by applying pressure on the paper, foil, or other lightweight media.

A gel pen uses ink in which pigment is suspended in a water-based gel. The ink is thick and opaque, and shows up more clearly on dark or slick surfaces than the typical inks used in ballpoint or felt tip pens. The general design of a gel pen is similar to that of a regular rollerball pen, with a barrel containing the writing mechanism and a cap, and a reservoir filled with ink. The barrels can be created in many different sizes and designs. The size of the nib or pen tip generally ranges from 0.18 mm to 1.5 mm. Gel pens can be used for many unique types of writing and illustration. In some embodiments, software is loaded into the cutting device that is specifically tailored to be executed when a pen or gel pen is attached to the cutting device.

One main advantage of gel ink is its high viscosity, which supports a higher proportion of pigments in the medium. The pigments are typically copper phthalocyanine and iron oxides, and the gel is made up of water and biopolymers, such as xanthan gum and tragacanth gum, as well as some types of polyacrylate thickeners. The pigments are opaque, and gel pens are available in a rainbow of bright and pastel colours, as well as opalescent, metallic, and glittery colors, which show up clearly on dark paper. Gel ink can also be manufactured in regular colors. Additionally, because of its unique properties, gel ink may also be manufactured to include: metallic, glitter, pastel, and swirl or rainbow colors. Gel ink is not available for consumer printers. Thus, the writing implements and writing implement holders of the present invention may be the only way for artist to mechanically draw or mark media using the gel based ink of a gel pen. The housing adds support or stability to the writing implement while the cutting device is marking or drawing on the medium.

Magnets do their best work when focused. The natural field of a magnet is polar radiating loops. Disc magnets have equal fields. However, by using a ferromagnetic backing plate, both fields working for you. Thus, a ferromagnetic backing plate placed against one side of the magnet creates a more efficient path for the flux lines to follow. It also creates a radiating pattern favoring one pole, which effectively points the majority of the magnetic energy in one direction.

When a magnet is placed in a ferromagnetic cup, the cup further magnifies the effect by eliminating the air gap (air is a poor conductor of magnetic fields) and brings both poles of the magnet to grip on the same surface. This is similar in principle to a horseshoe magnet. A rare-earth magnet in a steel cup provides four times the strength of a bare magnet, and in some embodiments of the invention, a rare earth magnet is used. A cup provides a disc magnet the optimal magnetic flux focus into the smallest gap area. In some embodiments of the invention, a cup is used instead of a ferromagnetic backing plate. In another embodiment of the invention, a magnet is placed in the inner cavity of the housing.

In some embodiments, the writing implement may have an end cap that conatins a magnetically-attractive material like steel. In yet another embodiment, a magnetically-attractive material is attached to the writing implement. In some embodiments, a steel ball is place near, or within an end cap. A steel ball that is placed within an end cap of a writing implement will be magnetically attracted to the magnet housed within the writing implement holder.

In some embodiments the writing implement holder is composed of metal but can be made from any ridged or hard surface e.g., wood or plastic. In some embodiments, the writing implement holder is composed of aluminum. In other some embodiments the writing implement holder is composed of anodized metals such as aluminum.

Anodizing is an electrochemical process that converts the metal surface into a decorative, durable, corrosion-resistant, anodic oxide finish. Aluminum is ideally suited to anodizing, although other nonferrous metals, such as magnesium and titanium, also can be anodized.

The anodic oxide structure originates from the aluminum substrate and is composed entirely of aluminum oxide. This aluminum oxide is not applied to the surface like paint or plating, but is fully integrated with the underlying aluminum substrate, so cannot chip or peel. It has a highly ordered, porous structure that allows for secondary processes such as coloring and sealing.

A metal like aluminum is anodized by immersing the aluminum into an acid electrolyte bath and passing an electric current through the medium. A cathode is mounted to the inside of the anodizing tank; the aluminum acts as an anode, so that oxygen ions are released from the electrolyte to combine with the aluminum atoms at the surface of the part being anodized. Anodizing is, therefore, a matter of highly controlled oxidation—the enhancement of a naturally occurring phenomenon. Anodized aluminum provides attractive, minimum-maintenance, highly durable surface and is considered environmentally safe.

In some embodiments, the writing implement holder has an inner diameter that is uniform along the length of the inner surface. Thus, the inner surface of the housing may have a uniform diameter along the length of the inner surface. In other embodiments the inner surface of the housing comprises a section or area that is located at the first open end and has greater diameter compared to the diameter of the remainder of said inner surface. This area creates a top edge where the greater diameter and reduced diameter meet. The greater diameter allows writing implement access and the top edge acts also as a stop collar to stop the writing implement from extending further up within the housing. This stop collar has prohibits the writing implement from slipping when downward pressure is exerted by the cutting machine.

In one embodiment, writing implement system can be configured such that the writing implement is magnetically mated with the writing implement holder. The writing implement may also be two-sided. The two-sided writing implement may have a magnetically-attractive cap that can be magnetically secured or attached to the writing implement holder of the present invention. The magnetically-attractive cap can then be placed on the opposite end of the writing implement and inserted into the writing implement holder allowing use of the opposite side of the writing implement. Thus, in one embodiment the writing implement has a magnetically-attractive material and can be located within the end cap of said writing implement.

In one embodiment the writing implement has a stop collar extending beyond the barrel diameter. This stop collar rests against the stop collar of the writing implement holder mentioned above. Thus, the stop collar of the writing implement is proximate to said inner surface of said housing where the inner surface has a top edge or stop collar. The stop collar on the writing implement holder comprises a section proximate said first open end that has a reduced diameter compared to the diameter of the remainder of said inner surface. This section or area of the writing implement holder allows the stop collar of the writing implement to be inserted into the writing implement holder.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

Various modifications of such specific embodiments based on the general disclosure of the systems, devices, and methods of the present invention can be made as will be clear to a skilled artisan.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference. The mere mentioning of the publications and patent applications does not necessarily constitute an admission that they are prior art to the instant application.

Although the foregoing invention has been described in some detail by way of illustration and example for purposes of clarity of understanding, it will be obvious that certain changes and modifications may be practiced within the scope of the appended claims.

What is claimed is:

1. A writing implement holder comprising:
a housing comprising an open first end, a closed second end, and a surface connecting said open first end with said closed second end, wherein an inner cavity is formed by said surface, wherein said inner cavity is
configured for mating with a writing implement and
wherein the exterior of said surface is configured to replace a blade holder of a cutting device and configured to removably mate with said cutting device and allow use of said writing implement in place of a blade with said cutting device.

2. The writing implement holder of claim 1, wherein said writing implement comprises a gel pen.

3. The writing implement holder of claim 1, wherein said implement holder is composed of aluminum.

4. The writing implement holder of claim 1, wherein the diameter of said inner surface of said housing is uniform along the length of said inner surface.

5. The writing implement holder of claim 1, wherein said housing comprises a hole communicating between said outer surface and said inner surface, wherein said hole is configured to allow slidable access to said writing implement when said writing implement is mated with said inner surface of said housing.

6. The writing implement holder of claim 5, wherein said hole is located in the side of said housing approximately halfway along the length of said outer surface of said housing.

7. The writing implement holder of claim 1, wherein said closed second end of said housing is configured for magnetically securing said writing implement.

8. The writing implement holder of claim 1, wherein said housing comprises a tube comprising an open first end and a closed second end, wherein the inner surface of said tube forms said inner cavity and is configured for mating with a writing implement and wherein the outer surface of said tube forms the exterior of said surface and is configured to replace a blade holder of a cutting device and configured to removably mate with said cutting device to allow use of said writing implement in place of a blade with said cutting device.

9. The writing implement holder of claim 8, wherein said outer surface of said tube comprises a reduced section proximate said first open end that has a reduced diameter compared to the diameter of the remainder of said outer surface, wherein said section is configured to removably mate with said cutting device.

10. The writing implement holder of claim 9, wherein said outer surface of said tube proximate said open first end includes a recessed band in said outer surface, wherein said recessed band is configured to removably mate with said cutting device.

11. The writing implement holder of claim 8, wherein said outer surface of said tube proximate said first open end further includes a protruding ring extending from said outer surface and proximate said recessed band, wherein said protruding ring in conjunction with said recessed band are configured to removably mate with said cutting device.

12. A writing implement system comprising:
a cutting device; and
a writing implement holder comprising:
a housing configured for mating with a writing implement and
configured to replace a blade holder of a cutting device and configured to removably mate with said cutting device and allow use of said writing implement in place of a blade with said cutting device.

13. The writing implement system of claim 12, further comprising a writing implement.

14. The writing implement system of claim 13, wherein said writing implement is mated with said implement holder.

15. The writing implement system of claim 12, wherein a blade holder of said cutting device has been replaced by said writing implement holder.

16. A method of using a cutting device to draw with a writing implement, said method comprising:
replacing a blade holder of a cutting device with a writing implement holder, wherein said writing implement holder comprises:
a housing configured for mating with a writing implement and
configured to replace a blade holder of a cutting device and configured to removably mate with said cutting device and allow use of said writing implement in place of a blade with said cutting device.

17. The method of claim 16, further comprising mating a writing implement with said writing implement holder.

18. The method of claim 17, further comprising programming a first pattern into said cutting device, inserting desired media into said cutting device, and activating said cutting device so as to draw said first pattern on said desired media with said writing implement.

19. The method of claim 17, further comprising programming a second pattern into said cutting device, and activating said cutting device so as to draw said second pattern on said desired media with said writing implement.

20. The method of claim 18, further comprising replacing said writing implement holder with said blade holder, inserting a blade, and activating said cutting device so as to cut a pattern into said desired media with said blade.
